(19) United States
(12) Patent Application Publication
(10) Pub. No.: US 2008/0267807 A1
(43) Pub. Date: Oct. 30, 2008

(54) CORE ROD FOR FORMING A CYLINDRICAL GREEN COMPACT, APPARATUS FOR FORMING A CYLINDRICAL GREEN COMPACT, AND METHOD FOR FORMING A CYLINDRICAL GREEN COMPACT

(76) Inventors: Kinya KOBAYASHI, Hitachi (JP); Hideaki NAGASHIMA, Kasumigaura (JP); Shuuichi ISHIZAWA, Hitachi (JP); Yuji ENOMOTO, Hitachi (JP); Tomoaki ARAKAWA, Matsudo (JP); Jiro SHIMA, Matsudo (JP); Chio ISHIHARA, Matsudo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/109,364

(22) Filed: Apr. 25, 2008

(30) Foreign Application Priority Data
Apr. 27, 2007 (JP) 2007-119661

(51) Int. Cl. B22F 3/02; B28B 17/00

(52) U.S. Cl. 419/66; 425/447

(57) ABSTRACT

A core rod for forming a cylindrical green compact having an axial protrusion or a radial step portion or dent portion on an inner surface of the cylindrical member by powder compaction, wherein: the core rod is provided with a step portion protruding in a radial direction at least a part on an outer surface thereof; the core rod is divided into two parts, an upper core and a lower core, on a plane that is flush with an upper surface of the step portion; and the upper core and lower core are mechanically joined with fastening members or bonded with an adhesive on a plane along which the core rod is divided.

### CLAIM OF PRIORITY

The present application claims priority from Japanese application serial No. 2007-119661, filed on Apr. 27, 2007, the content of which is hereby incorporated by reference into this application.

### BACKGROUND OF THE INVENTION

1. Field of the Invention

The present invention relates to a core rod for forming a cylindrical green compact as well as an apparatus equipped with the core rod for forming a cylindrical green compact and a method for forming a cylindrical green compact. Cylindrical green compact referred to in this description have concentric inner and outer surfaces. Ring-shaped members having a height smaller than an outer diameter thereof are also considered as cylindrical green compact.

2. Description of Related Art

To manufacture a cylindrical green compact by powder compaction, a core rod, lower punch, upper punch, and die are usually used as described in, for example, Patent Document 1. In the method in Patent Document 1, powder is filled between the upper punch and lower punch, and the upper punch and lower punch are relatively moved to form a multi-layer cylindrical green compact.

Patent Document 1: Japanese Patent Application Laid-open Publication No. 2006-305578 (Abstract)

### SUMMARY OF THE INVENTION

The following problems arise when a method for green compact is used to manufacture doughnut-shaped or cylindrical green compact that have a protrusion in the axial direction or a step portion or dent portion in a radial direction on the inner surface.

First, since minimum widths of the punches are fixed, it is difficult to obtain a cylindrical green compact having a protrusion end surface, step portion, or dent portion with a small radial width δ.

Another problem is that when the height of a step portion of a cylindrical green compact formed by punches is denoted h, it is difficult to enlarge h/δ because a large load has to be applied.

These problems may be solved when a stepped core rod is used to form the inner surface of the cylindrical green compact so that powder compaction is performed by the step portion of the stepped core rod instead of the punches.

However, when the stepped core rod is used, it is difficult to reduce the curvature radius R of a corner at a part on the inner surface that is linked to the end of the protrusion of the cylindrical green compact, to the upper or lower surface of the step portion, or to the upper or lower surface of the dent portion.

In the stepped core rod, stress concentrates on the corner of the step portion. At the corner, tensility is generated by a combination of a force applied to the upper surface of the stepped structure and a force applied to the side of the core at the upper part of the stepped structure. When the curvature radius of the corner at the step portion of the stepped core rod is denoted R, the curvature radius of the corner corresponding to the step portion of the green compact formed by using the core rod is R. In this case, the stress at the corner at the step portion of the stepped metal mold is 1/R^{λ}; λ is a positive constant; the stress is proportional to the force applied to green compact. If R approaches 0 and the stress at the corner exceeds its breaking strength, no problem occur at other parts but cracks may be generated only at the corner.

An object of the present invention is to provide a core rod for forming a cylindrical green compact, an apparatus for forming a cylindrical green compact equipped with the stepped core rod, and a method for forming a cylindrical green compact that are applicable to powder compaction in which a stepped core rod is used to form cylindrical green compact having an axial protrusion or a radial step portion or dent portion on the inner surface; the inventive stepped core rod causes cracks to be less likely to occur at the corner at a joint between the step portion and the side surface linked to the step portion even when the curvature radius of the corner is small. Another object of the present invention is to provide a cylindrical green compact formed by the inventive stepped core rod.

A core rod of the present invention for forming a cylindrical green compact having an axial protrusion or a radial step portion or dent portion on an inner surface of the cylindrical member by powder compaction, wherein: the core rod is provided with a step portion protruding in a radial direction at least a part on an outer surface thereof; the core rod is divided into two parts, an upper core and a lower core, on a plane that is flush with an upper surface of the step portion; and the upper core and lower core are mechanically joined with fastening members or bonded with an adhesive on a plane along which the core rod is divided.

In a preferred embodiment of the present invention, further comprising; the upper core and lower core of the core rod are joined with a bolt or screw at the center of the plane along which the core rod is divided; or by forming a concave in one of the divided core and a convex on the other divided core, and fitting the divided cores to each other.

In another preferred embodiment of the present invention, further comprising; at least one of the upper core and lower core is surface-treated by shot peening on the plane along which the core rod is divided, so as to provide compressed residual stress.

An apparatus of the present invention for forming a cylindrical green compact having an axial protrusion or a radial step portion or dent portion on an inner surface of the cylindrical member by powder compaction, the apparatus comprising: a core rod which is provided with a step portion protruding in a radial direction at least a part on an outer surface thereof, and being divided into an upper core and a lower core on a plane that is flush with an upper surface of the step portion; and the upper core and lower core are mechanically joined with fastening members or bonded with an adhesive on a plane along which the core rod is divided; an upper punch and a lower punch disposed on an outer surface of the core rod; and a die disposed on outer surfaces of the upper punch and the lower punch; wherein the powder is filled between the upper punch and the lower punch, and the upper punch and the lower punch are relatively moved to apply a load to the powder for forming a cylindrical green compact.

A method of the present invention for forming a cylindrical green compact having an axial protrusion or a radial step portion or dent portion on an inner surface of the cylindrical member by powder compaction, the method comprising the steps of: using a core rod which is provided with a step portion protruding in a radial direction at least a part on an outer surface thereof, and divided into an upper core and a lower core on a plane that is flush with an upper surface of the step portion, mechanically joining with fastening members or bonding with an adhesive the upper core and lower core with fastening members on a plane along which the core rod is divided; disposing an upper punch and a lower punch on an outer surface of the core rod; disposing a die on outer surfaces of the upper punch and the lower punch; filling powder between the upper punch and the lower punch and between the core rod and the die; and relatively moving the upper punch and the lower punch to apply a load to the powder for forming a cylindrical green compact.

The core rod of the present invention preferably further comprising, the upper core of the divided two cores, the upper core and the lower core, is capable of being replaced to a modified upper core in response to a shape of the green compact formed by powder compaction.

The method of the present invention further comprising the steps of: fixing the lower punch above the step portion formed on the outer surface of the core rod; and moving the upper punch for powder compaction of the powder filled between the upper punch and the lower punch so as to form a cylindrical member having a protrusion in an axial direction at least one part on an inner surface of the cylindrical member.

The method of the present invention, further comprising the steps of: fixing the lower punch below the step portion formed on the outer surface of the core rod; and moving the upper punch for powder compaction of the powder filled between the upper punch and the lower punch so as to form a cylindrical member having a dent in a radial direction at least one part on an inner surface of the cylindrical member.

The stepped core rod in the present invention divided into two parts, an upper core and a lower core, on a plane that is flush with the upper surface of the step portion, so the corner at a joint between the step portion and the side surface linked to the step portion is less likely to be damaged for the reasons described below.

1) Since both of the material of the side and the material of the bottom of the core rod are not integrated, both the stress of the bottom and the stress of the side are not applied to the corner.

2) Although a strong load is vertically applied to the surface of the step portion, tensile stress at the step portion is reduced because the upper core and lower core are joined on a plane flush with the stepped surface of the core rod.

3) Cracks do not develop because the core rod is divided on a plane that is flush with the upper surface of the step portion.

For this reason, even when the corner between the upper surface of the step portion and the core rod side surface linked to the upper surface is not curved or its curvature radius is small, stress concentrated on the corner can be reduced.

In addition, when shot peening is performed on the core cross section including the stepped surface before the cores are joined so as to apply initial compression force to the corner at which stress concentrates, life to destruction can be significantly prolonged.

### BRIEF DESCRIPTION OF THE DRAWINGS

FIGS. 1A and 1B are schematic diagrams of a stepped core rod for forming a green compact used in a comparative example.

FIG. 2 is a structural diagram of an apparatus for forming a green compact used in the comparative example, illustrating a state before powder compaction is performed.

FIG. 3 is a structural diagram of the apparatus for forming a green compact used in the comparative example, illustrating a state after powder compaction is performed.

FIGS. 4A and 4B are schematic diagrams of a green compact used in the comparative example.

FIGS. 5A to 5C are schematic diagrams of a stepped core rod for forming a cylindrical green compact used in a first embodiment of the present invention.

FIG. 6 is a structural diagram of an apparatus for forming a cylindrical green compact having the stepped core rod of the present invention used in the first embodiment, illustrating a state before powder compaction is performed.

FIG. 7 is a structural diagram of the apparatus for forming a cylindrical green compact having the stepped core rod of the present invention used in the first embodiment, illustrating a state after powder compaction is performed.

FIGS. 8A and 8B are schematic diagrams of a green compact obtained by the apparatus of the present invention in the first embodiment.

FIGS. 9A and 9B are structural diagrams of an apparatus for forming a cylindrical green compact having the stepped core rod of the present invention used a second embodiment, illustrating a state before and after powder compaction is performed, respectively.

FIGS. 10A and 10B are schematic diagrams of a green compact obtained by the powder compaction apparatus of the present invention in the second embodiment.

FIGS. 11A and 11B are schematic diagrams of a stepped core rod for forming a cylindrical green compact used in a third embodiment of the present invention.

FIG. 12 is a structural diagram of an apparatus for forming a cylindrical green compact having the stepped core rod of the present invention used in the third embodiment, illustrating a state after powder compaction is performed.

FIG. 13 is a schematic diagram of a green compact obtained by the powder compaction apparatus of the present invention in the third embodiment.

FIG. 14 is a structural diagram of an apparatus for forming a cylindrical green compact having the stepped core rod of the present invention used in a fourth embodiment, illustrating a state after powder compaction is performed.

FIG. 15 is a schematic diagram of a green compact obtained by the apparatus of the present invention in the fourth embodiment.

FIG. 16 is a structural diagram of an apparatus for forming a cylindrical green compact having the stepped core rod of the present invention used in a fifth embodiment, illustrating a state after powder compaction is performed.

FIG. 17 is a schematic diagram illustrating an exemplary green compact obtained by the apparatus of the present invention in the fifth embodiment.

FIG. 18 is a schematic diagram illustrating another exemplary green compact obtained by the powder compaction apparatus of the present invention in the fifth embodiment.

FIG. 19 is a schematic diagram illustrating a green compact obtained by the apparatus of the present invention in the fifth embodiment.

FIGS. 20A and 20B are schematic diagrams illustrating another exemplary stepped core rod for forming a cylindrical green compact used in a eleventh embodiment of the present invention.

### DETAILED DESCRIPTION OF THE PREFERRED EMBODIMENTS

Embodiments of the present invention will be described below with reference to the drawings.

### Comparative Example

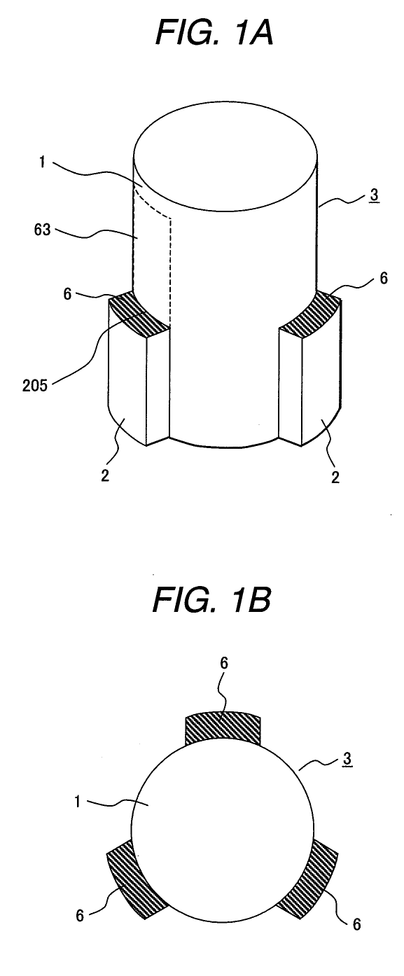

An example in which a stepped core rod that is not horizontally divided at the step portion will be described first with reference to FIGS. 1A, 1B, 2, 3, 4A, and 4B.

FIG. 1A is a perspective view of a stepped core rod 3 viewed from its side. FIG. 1B is its plan view viewed from above. The stepped core rod 3 comprises a core body 1, which is column-shaped, and three step portions 2, which are convex protruding in radial directions and disposed on the outer surface of the core body 1 in a peripheral direction.

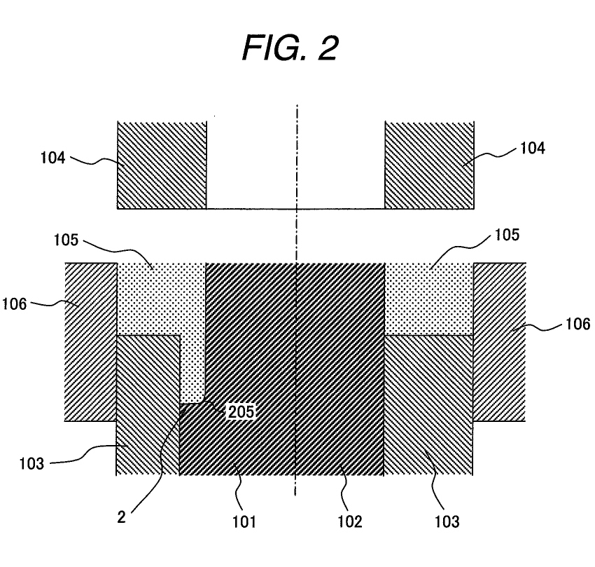

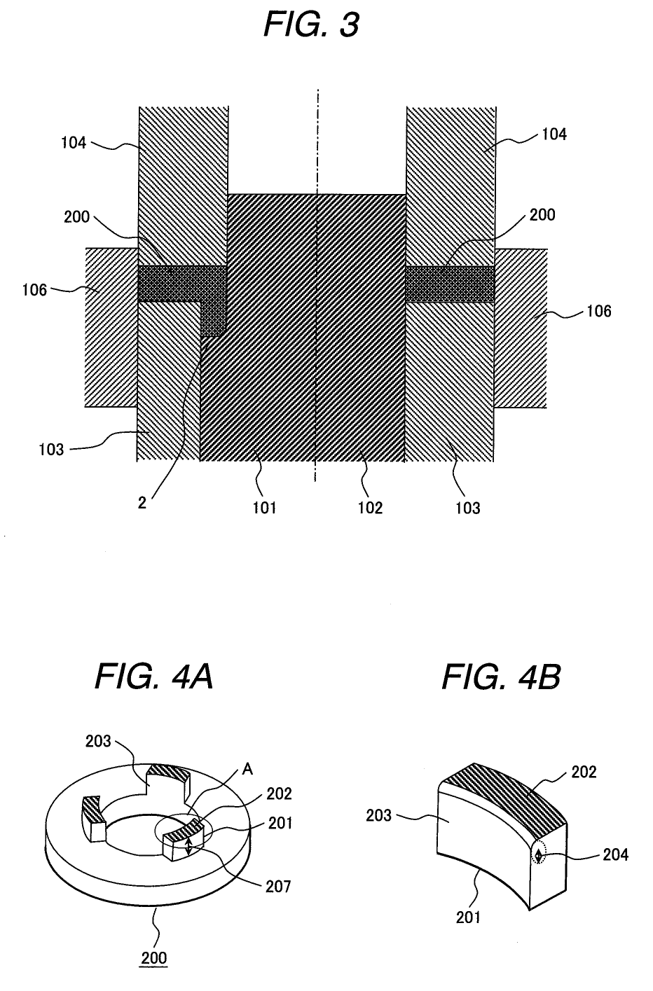

FIGS. 2 and 3 show the structure of a powder compaction apparatus equipped with the above stepped core rod. FIG. 4A shows a green compact which is manufactured by the above powder compaction apparatus. FIG. 4B is an enlarged view of the inner surface of portion A in FIG. 4A.

FIGS. 2 and 3 respectively show the structures of the powder compaction apparatus in states before and after powder compaction is performed. The left sides of the central lines in FIGS. 2 and 3 show the apparatus structure at the core 101 in which a step portion is included, and the right sides show the apparatus structure at the core 102 in which no step portion is included.

A lower punch 103 is disposed on the outer surface of the stepped core rod 3, and a die 106 is disposed on the outer surface of the lower punch 103. In powder compaction, powder 105 is filled in a cavity which is formed by the die 106, the lower punch 103 and the stepped core rod 3, and then a load is applied to the upper punch 104, and a load is also applied from the lower side as the lower punch 103 and the core rod 101 are relatively raised. A green compact 200 as shown in FIGS. 4A and 4B, which is cylindrical and has a protrusion extending on the inner surface, is then obtained.

With the stepped core rod 3 shown in FIG. 1, the end surface 202 of the protrusion 201 of the green compact 200 is formed on the upper surface of the step portion 2 formed on the core body 1, the upper surface being referred to below as the step's upper surface 6.

During powder compaction, forces are applied through the powder 105 to the upper surface 6 of the step portion 2 of the core rod 3 and to a side surface 63 of the core rod 3 linked to the upper surface 6. The ratio between the vertical load applied to the upper surface 6 of the step portion 2 and that to the side surface 63 is fixed. A tensile stress concentrates on a corner 205 between the upper surface 6 of the step portion 2 and the side surface 63 due to the loads applied to the upper surface 6 of the step portion 2 and the side surface 63.

When the curvature radius of the corner 205 is denoted R, stress concentration at the corner 205 is 1/R^{λ}; λ is a positive constant; that is, it is proportional to the applied pressure. If the corner 205 is curved with a large curvature radius, cracks are less likely to occur at the corner 205. If, however, the curvature radius is reduced, for example, to zero, stress concentrates on the corner and thereby cracks occur in the core rod 3, starting from the corner 205.

The reference numerals 203, 204, and 207 in FIGS. 4A and 4B indicate the internal surface 203 of the protrusion of the green compact 200, the curvature radius 204, and the height 207 of the extrusion on the green compact 200.

### First Embodiment

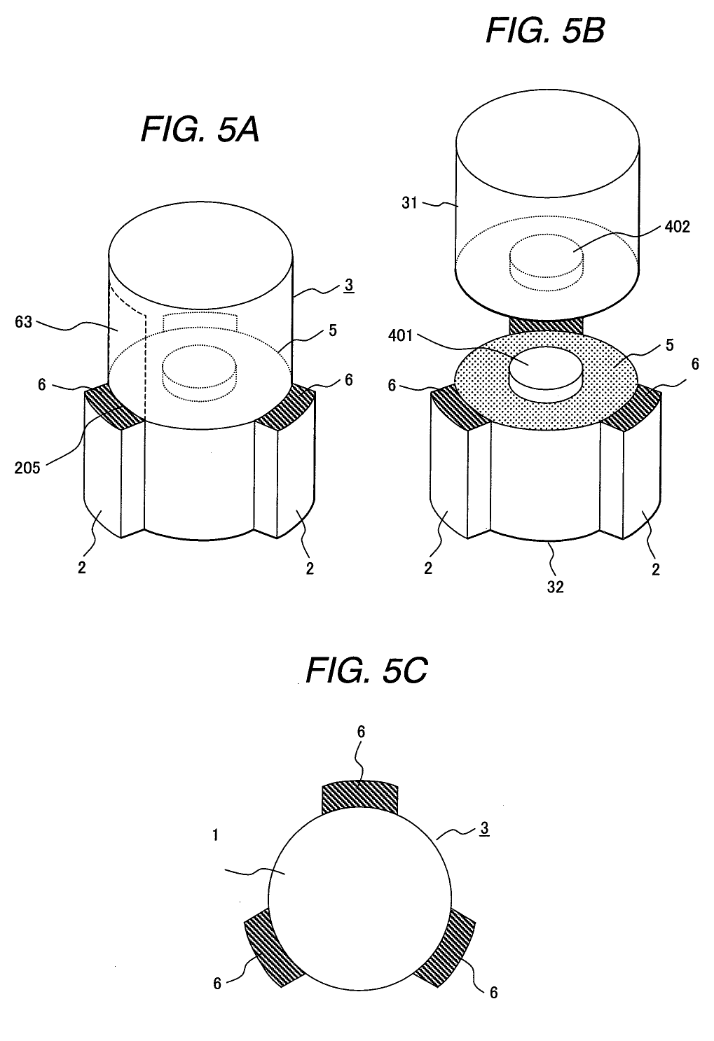

A first embodiment of the present invention will be described below with reference to FIGS. 5A to 5C, 6, 7, and 8A and 8B.

FIGS. 5A to 5C show the structure of the stepped core rod 3. FIG. 5A is a perspective view in a state in which the upper core 31 and lower core 32 are joined. FIG. 5B is a perspective view when the upper core 31 and lower core 32 are separated. FIG. 5C is a plan view viewed from above.

The stepped core rod 3 has three step portions 2 spaced in the peripheral direction, each of which has a convex protruding in a radial direction. The stepped core rod 3 is horizontally divided into two parts, an upper core 31 and a lower core 32, on a plane flush with the step's upper surface 6. The cross section 5 of the stepped core rod 3 is joined with the step's upper surface 6, their surfaces being flush with each other.

The upper core 31 and lower core 32 are joined on the cross section 5 in a manner in which they can be separated. In FIGS. 5A to 5C, a bolt 401 is attached at the center of the lower core 32, and a nut 402 is attached at the center of the upper core 31. The upper and lower cores 31, 32 are strongly joined with the bolt 401 and the nut 402 on the cross section 5. The method of joining the upper and lower cores 31, 32 is not limited to tightening with the bolt and the nut; they may be fitted by forming a concave in one of the upper core 31 and the lower core 32 and a convex on the other.

With the stepped core rod 3 in FIGS. 5A to 5C, shot peening is applied to the upper surface and lower surface of the cross section 5, the upper surface 6 of the step portion 2, and the side surface 63 of the core rod 3 so as to provide compressed residual stress.

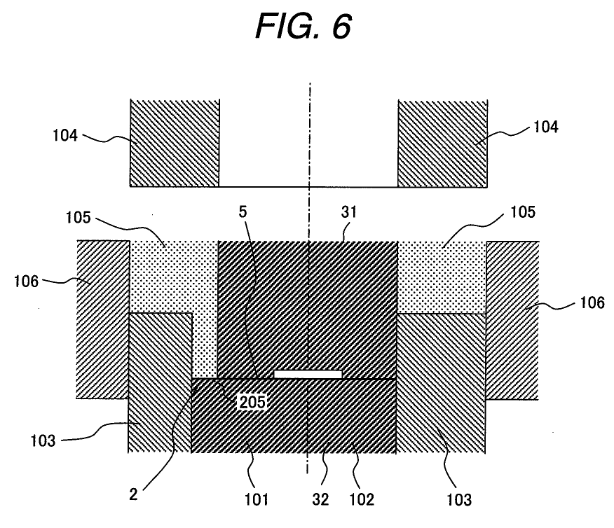

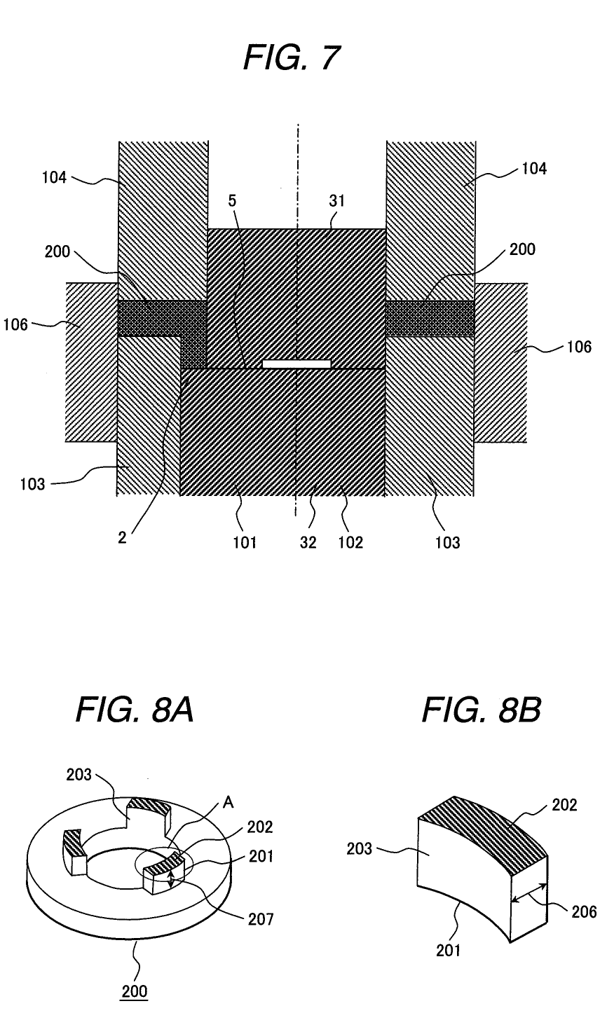

FIGS. 6 and 7 show the structures of a powder compaction apparatus equipped with the stepped core rod 3 in FIGS. 5A to 5C in states before and after powder compaction is performed, respectively. The left sides of the central lines in FIGS. 6 and 7 show the apparatus structure at the core 101 in which a step portion 2 is included, and the right sides show the apparatus structure at the core 102 in which no step portion is included. The corner 205 on the upper surface of the step portion 2 of the stepped core rod 3 is not curvature.

The lower punch 103 is disposed on the outer surface of the stepped core rod 3, and the die 106 is disposed on the outer surface of the lower punch 103. To form the green compact 200, powder 105 is filled in a cavity which is formed by the die 106, the lower punch 103 and the stepped core rod 3, and then a load is applied to the upper punch 104, and a load is also applied from the lower side as the lower punch 103 and the core rod 101 are relatively raised.

Soft magnetic powder core was used to form a green compact 200(700) for a powder core. A load was applied by a press so that the entire density of the green compact became 92% or more of the true density of the material constituting the powder. A green compact 200 having a structure shown in FIGS. 8A and 8B was then obtained.

If this situation occurs in the above comparative example, cracks are usually generated on the cross section on which the upper core and lower core are joined and thereby the core rod is damaged in a short period of time. The higher the relative density of the green compact is, the shorter the life of the core rod is. In this embodiment, however, the core rod is horizontally divided into the upper core and lower core on a plane flush with the upper surface of the step portion and then the divided upper core and lower core are joined, so the core rod is not damaged. Stress applied to the cores was calculated according to the three-dimensional finite element method. The calculation result indicated that the maximum stress applied to the cores is about half that in the comparative example.

Furthermore, shot peening is performed to apply a compressed residual stress to the upper surface and lower surface of the cross section 5, the upper surface 6 of the step portion 2, and the side surface 63 of the core rod 3, and thereby high-cycle life of the core rod to destruction is prolonged.

According to this embodiment, a green compact 200 having three protrusions 201 at the bottom of the doughnut-shaped structure in the peripheral direction, as shown in FIG. 8A is formed. FIG. 8B is an enlarged view of the inner surface of portion A in FIG. 8A.

In this embodiment, the joint between the end surface 202 and the inner surface 203 of the protrusion 201 on the green compact 200 is not curved. The curvature radius on the joint between the end surface 202 and the inner surface 203 of the protrusion 201 on the green compact 200 in this embodiment can be reduced to nearly zero in comparison with the curvature radius 204 shown in FIG. 4B. By comparison, the curvature radius 204 in the comparative example shown in FIG. 4B is curved with a curvature radius of 0.5 mm. A flat area on the end surface of the non-curved structure in this embodiment shown in FIG. 8B is wider than a flat area on the end surface of the curved structure in FIG. 4B. Accordingly, in this embodiment, even when the width 206 of the end surface 202 of the protrusion 201 on the green compact 200 is small, the flat area on the end surface 202 can be enlarged.

When the flatness of the end surface 202 of the protrusion 201 of powder core 200 is increased, the following effects are obtained.

1) When an axial gap motor, in which the end surfaces of the extrusions on the green compact is close to magnet of rotor and thereby gaps among them are small, or a similar product is used, flat end surfaces make it hard to stop the rotation of the motor and suppress noise when the extrusions touch one another.

2) When the protrusions are stacked on their end surfaces, if the end surface is flat, the tightness of contact among them is increased.

When the end surface is jointed to a plane-shaped member, the joining area can be maximized, increasing the contact force. In addition, unnecessary space can be eliminated.

3) A flat end surface is preferable in thin units because their thicknesses can be reduced.

The curvature radius R on the joint between the end surface 202 and the inner surface 203 of the protrusion 201 on the green compact 200 in this embodiment is 0. Even if the curvature radius R is not 0, when R/δ is smaller than 0.2 or R is smaller than 0.1 mm, the above effects are sufficiently obtained; in this case, δ is the width 206 of the end surface 202 of the protrusion 201. The effects are further increased as R/δ is reduced to smaller than 0.1 and to smaller than 0.05. The effects are also increased as R is reduced to smaller than 0.1 mm and to smaller than 0.05 mm.

When the entire density of the green compact 200 is increased to as high as 92% or more of the true density of the material constituting the powder, the following effects are obtained.

1) The strength of the green compact is increased.

2) The green compact is advantageous when it is mounted in a mounted part in which space is limited.

3) Net shaping is possible for forming, increasing the productivity.

When the core rod is used for the compacting of, for example, a motor core made of a powder core material, the following effects are further obtained.

4) The magnetic flux density is increased and thereby the motor output and motor torque are increased.

5) When the magnetic flux density is the same as before, the powder core can be made compact.

As the entire density of the green compact is increased to 94% or more and to 96% or more of the true density of the material constituting the powder, the above effects are further increased.

Since the maximum stress is eliminated, the following effects are also obtained.

1) Stresses are averaged and thereby the density of the green compact can be made uniform.

2) The residual stress, which concentrates on a single place of the powder core, can be reduced and thereby the hysteresis loss is reduced.

3) When a powder core is formed by compacting soft magnetic powder material with insulating coating, stresses are averaged and are not localized, so the insulating coatings are less destructed and eddy current loss is reduced.

4) The life of the die assembly is prolonged.

Although three protrusions 201 of the green compact 200 are used in this embodiment, even when a different number of protrusions 201 are used, the same effects are obtained.

### Second Embodiment

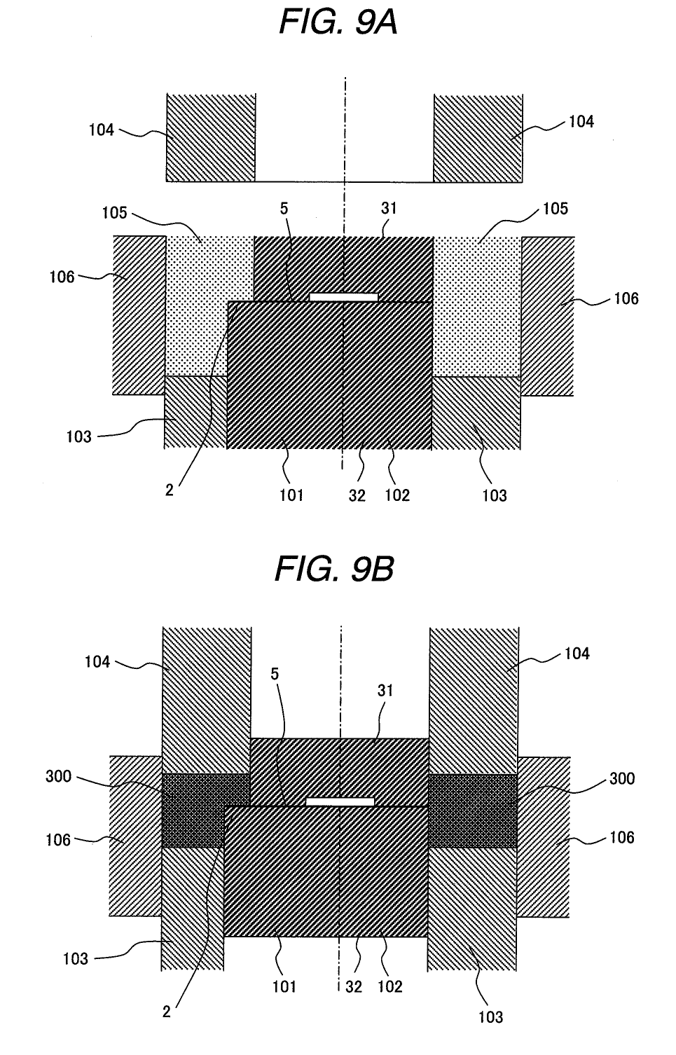

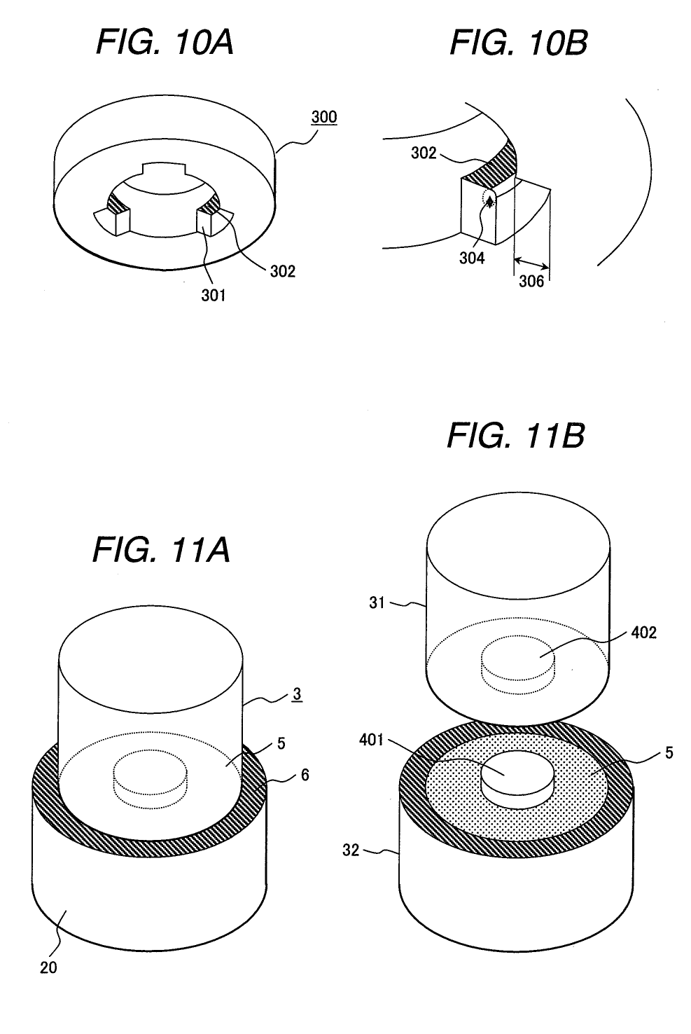

A second embodiment in which a green compact with dent portions is formed will be described with reference to FIGS. 9A, 9B, 10A, and 10B. FIGS. 9A and 9B respectively show the powder compaction apparatus before and after compacting is performed.

A powder compaction apparatus structured as in the first embodiment can be used to form a cylindrical or ring-shaped green compact 300 having dent portions 301 on the inner surface. As shown in FIGS. 9A and 9B, however, the lower punch 103 is disposed below the upper surface of the step portion 2 of the stepped core rod 3.

A load is applied by a press so that the entire density of the green compact 300 becomes 92% or more of the true density of the material constituting the powder, as in the first embodiment.

With the powder compaction apparatus structured as in FIGS. 9A and 9B, a green compact 300 having three dent structures 301 on the lower surface of the ring-shaped structure in the peripheral direction is formed, as shown in FIG. 10B.

The dent surface of the dent structure 301 is flat, that is, the curvature radius R 304 divided by the width 306 is 0.19.

Accordingly, even when the width 306 is small, the flat area on the dent surface can be enlarged.

When the flatness of the dent surface is increased, the following effects are obtained.

1) When the dent surface of the dent structure 301 is flat, the tightness of contact is increased.

When the dent surface is jointed to a plane-shaped material, the joining area can be maximized, increasing the contact force. In addition, unnecessary space can be eliminated.

2) A flat surface is preferable in thin units because their thicknesses can be reduced.

In this embodiment, R/δ is 0.19, where δ is the width 306 of the dent structure 301.

As R/δ is reduced to smaller than 0.1 and to smaller than 0.05, the above effects are further increased.

When the entire density of the green compact 300 is increased to as high as 92% or more of the true density of the material constituting the powder, the following effects are obtained.

1) The strength of the green compact is increased.

2) The green compact is advantageous when it is mounted in a mounted part in which space is limited.

3) Net shaping is possible for forming, increasing the productivity.

When the core rod is used for the compacting of a motor core made of, for example, a powder core material, the following effects are further obtained.

4) The magnetic flux density is increased and thereby the motor output and motor torque are increased.

5) When the magnetic flux density is the same as before, the powder core can be made compact.

As the entire density of the green compact is increased to 94% or more and to 96% or more of the true density of the material constituting the powder, the above effects are further increased.

Since the maximum stress is eliminated, the following effects are also obtained.

1) Stresses are averaged and thereby the density of the green compact can be made uniform.

2) The residual stress, which concentrates on a single place of the powder core, can be reduced and thereby the hysteresis loss is reduced.

3) When a powder core is formed by compacting soft magnetic powder material with insulating coating, stresses are averaged and are not localized, so the insulating coatings are less destructed and eddy current loss is reduced.

4) The life of the die assembly is prolonged.

Although three dent portions 301 of the green compact 300 are used in this embodiment, even when a different number of dent portions 301 are used, the same effects are obtained.

### Third Embodiment

A third embodiment in which a core rod 3 having a cylindrical step portion 20 is used will be described with reference to FIGS. 11A, 11B, 12, and 13.

The stepped core rod 3 shown in FIGS. 11A and 11B has a cylindrical step portion 20. The core rod 3 is horizontally divided into two parts, an upper core 31 and a lower core 32, on a plane flush with the step's upper surface 6 of the cylindrical step portion 20. The upper core 31 and lower core 32 are joined with a bolt 401 and a nut 402 on the plane along which the core rod 3 is divided. Shot peening is applied to the step's upper surface 6 of the lower core 32, the cross section 5, which is the dividing surface, and the outer surface of the upper core 31 so as to provide compressed residual stress.

FIG. 12 shows the structure of the powder compaction apparatus in a state after powder compaction is performed. The corner at the stepped structure of the cylindrical step portion 20 is not curvature.

The lower punch 103 is disposed on the outer surface of the stepped core rod 3, and the die 106 is disposed on the outer surface of the lower punch 103. To form a cylindrical green compact 600, powder 105 is filled in a cavity which is formed by the die 106, the lower punch 103 and the stepped core rod 3, and a pressure is applied to the upper punch 104, and a load is also applied from the lower side as the lower punch 103 and the lower core 32 are relatively raised.

Soft magnetic powder was used to form a green compact 600 for a powder core. A load was applied by a press so that the entire density of the green compact 600 became 92% or more of the true density of the material constituting the powder. In this situation, cracks may be usually generated on the cross section 5 on which the upper core 31 and lower core 32 are joined and the core rod 3 is damaged in a short period of time. In this embodiment, however, the core rod 3 is horizontally divided into the upper core 31 and lower core 32 and then joined on the cross section 5 on which the core rod 3 is divided, so no damage occurs. Furthermore, shot peening is performed to apply to the upper surface 6 of the lower core 32, the cross section 5, which is the dividing surface, and the outer surface of the upper core 31 so as to provide a compressed residual stress, and thereby high-cycle life of the core rod to destruction is prolonged.

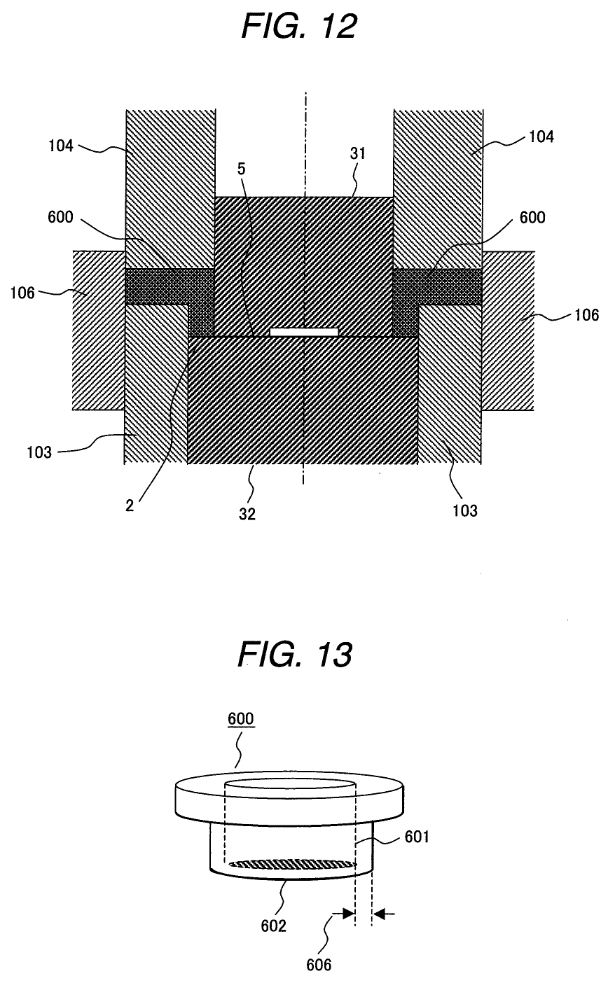

According to this embodiment, a cylindrical green compact 600 having a protrusion structure 601 at the bottom of the ring-shaped structure, as shown in FIG. 13, is formed.

Even when the width 606 of the end surface 602 of the protrusion structure 601 is small, the flat area on the end surface 602 can be enlarged.

When the flatness of the end surface 602 of the protrusion structure 601 of green compact 600 is increased, the following effects are obtained.

1) When an axial gap motor, in which the end surfaces of the extrusion structures of the green compact is close to magnet of rotor and thereby gaps among them are small, or a similar product is used, flat end surfaces make it hard to stop the rotation of the motor and suppress noise when the extrusions touch one another.

2) When the protrusion structures are stacked on their end surfaces, if the end surface is flat, the tightness of contact among them is increased.

When the end surface is jointed to a plane-shaped material, the joining area can be maximized, increasing the contact force. In addition, unnecessary space can be eliminated.

3) A flat end surface is preferable in thin units because their thicknesses can be reduced.

The curvature radius R in this embodiment is 0. Even if the curvature radius R is not 0, when R/δ is smaller than 0.2 or R is smaller than 0.1 mm, the above effects are sufficiently obtained; δ is the width 606 of the end surface.

The effects are further increased as R/δ is reduced to smaller than 0.1 and to smaller than 0.05. The effects are also increased as R is reduced to smaller than 0.1 mm and to smaller than 0.05 mm.

When the entire density of the green compact is increased to as high as 92% or more of the true density of the material constituting the powder, the following effects are obtained.

1) The strength of the green compact is increased.

2) The green compact is advantageous when it is mounted in a mounted part in which space is limited.

3) Net shaping is possible for forming, increasing the productivity.

When the core rod is used for the compacting of, for example, a motor core made of a powder core material, the following effects are further obtained.

4) The magnetic flux density is increased and thereby the motor output and motor torque are increased.

5) When the magnetic flux density is the same as before, the powder core can be made compact.

As the entire density of the green compact is increased to 94% or more and to 96% or more of the true density of the material constituting the powder, the above effects are further increased.

Since the maximum stress is eliminated, the following effects are also obtained.

1) Stresses are averaged and thereby the density of the green compact can be made uniform.

2) The residual stress, which concentrates on a single place of the powder core, can be reduced and thereby the hysteresis loss is reduced.

3) When a powder core is formed by compacting soft magnetic powder material with insulating coating, stresses are averaged and are not localized, so the insulating coatings are less destructed and eddy current loss is reduced.

4) The life of the die assembly is prolonged.

### Fourth Embodiment

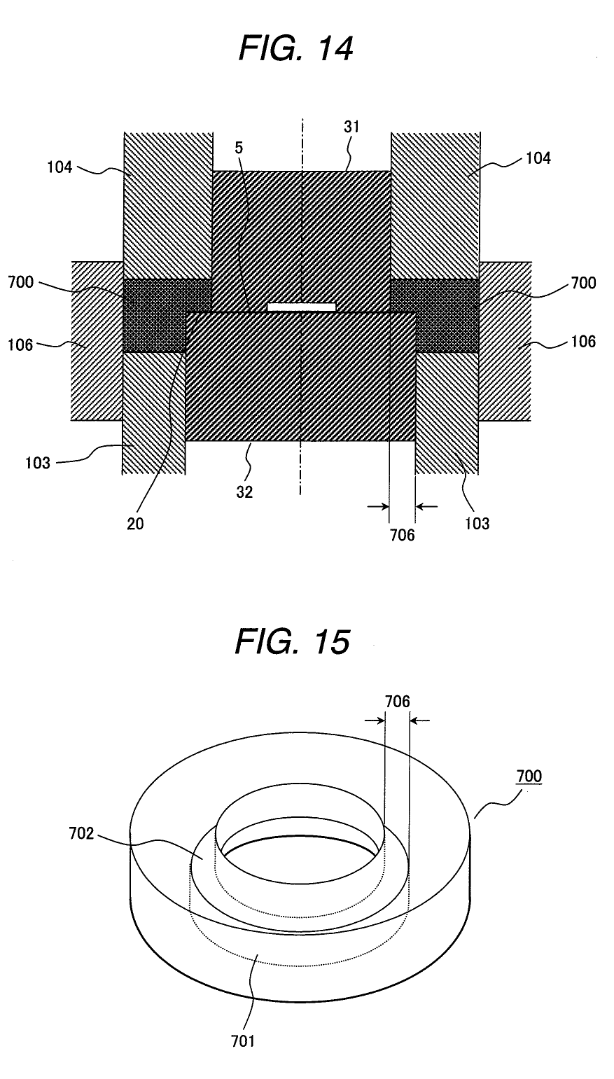

A fourth embodiment in which a core rod 3 having the cylindrical step portion 20 shown in FIG. 11 will be described with reference to FIGS. 14 and 15.

In this embodiment, as shown in FIG. 14, the lower punch 103 is disposed below the upper surface of the cylindrical step portion 20 of the stepped core rod. Accordingly, a cylindrical green compact 700 shaped as shown in FIG. 15 is obtained.

A powder core was used as the powder. A load was applied by a press so that the entire density of the green compact 700 became 92% or more of the true density of the material constituting the powder. In this situation, cracks are usually generated on the cross section on which the upper core and lower core are joined and the core rod may be damaged in a short period of time. In this embodiment, however, the core rod is horizontally divided into the upper core 31 and the lower core 32 and then joined on the cross section 5 on which the core rod 3 is divided, so no damage occurs.

The dent surface of the dent structure 701 is flat, that is, the curvature radius R divided by the width 706 is 0.19.

When the flatness of the dent surface is increased, the following effects are obtained.

1) When the dent surface of the dent structure is flat, the tightness of contact is increased.

When the dent surface is jointed to a plane-shaped material, the joining area can be maximized, increasing the contact force. In addition, unnecessary space can be eliminated.

2) A flat surface is preferable in thin units because their thicknesses can be reduced.

In this embodiment, R/δ is 0.19, where δ is the width 706 of the dent.

As R/δ is reduced to smaller than 0.1 and to smaller than 0.05, the above effects are further increased.

When the entire density of the green compact is increased to as high as 92% or more of the true density of the material constituting the powder, the following effects are obtained.

1) The strength of the green compact is increased.

2) The green compact is advantageous when it is mounted in a mounted part in which space is limited.

3) Net shaping is possible for forming, increasing the productivity.

When the core rod is used for the compacting of a motor core made of, for example, a powder core material, the following effects are further obtained.

4) The magnetic flux density is increased and thereby the motor output and motor torque are increased.

5) When the magnetic flux density is the same as before, the powder core can be made compact.

As the entire density of the green compact is increased to 94% or more and to 96% or more of the true density of the material constituting the powder, the above effects are further increased.

Since the maximum stress is eliminated, the following effects are also obtained.

1) Stresses are averaged and thereby the density of the green compact can be made uniform.

2) The residual stress, which concentrates on a single place of the powder core, can be reduced and thereby the hysteresis loss is reduced.

3) When a powder core is formed by compacting soft magnetic powder material with insulating coating, stresses are averaged and are not localized, so the insulating coatings are less destructed and eddy current loss is reduced.

4) The life of the die assembly is prolonged.

### Fifth Embodiment

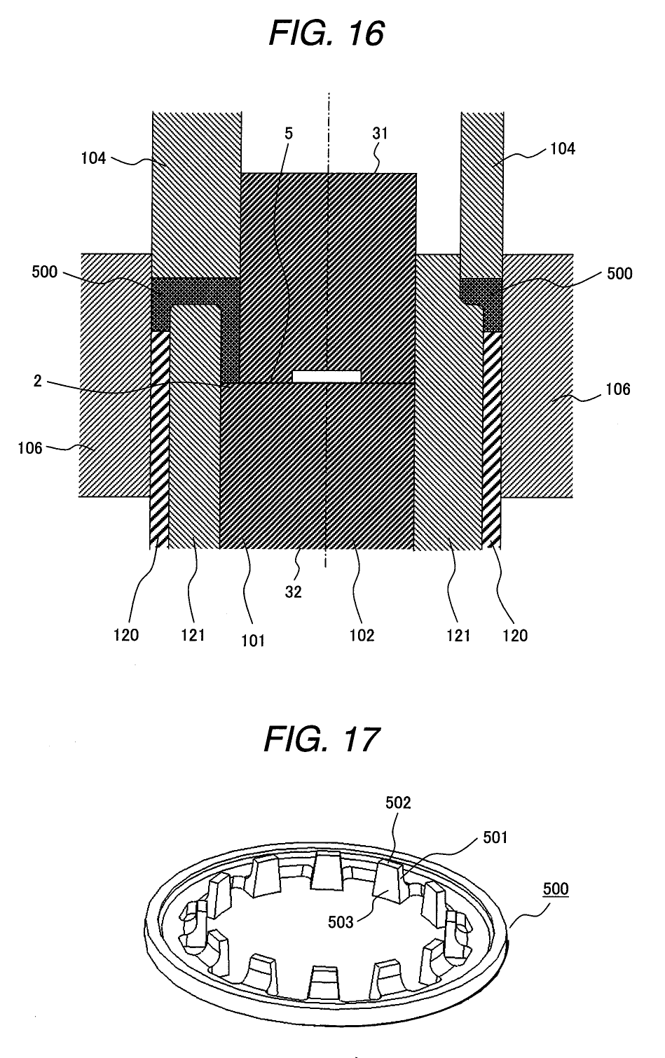

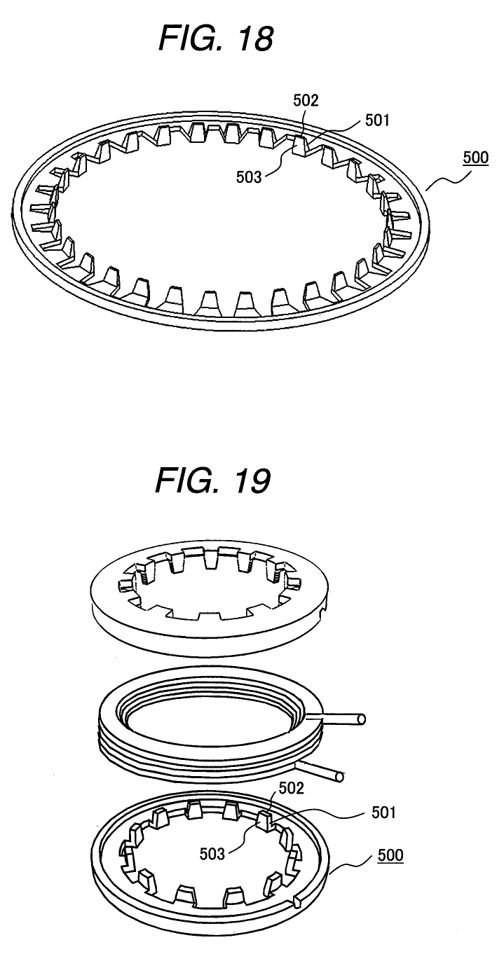

A fifth embodiment in which a 3D motor core is formed by powder compaction will be described below with reference to FIGS. 16 to 19.

FIG. 16 shows the structure of a powder compaction apparatus in a state after powder compaction has been performed. The left side in FIG. 16 shows the apparatus structure at the core 101 in which a step portion 2 is included, and the right side shows the apparatus structure at the core 102 in which no step portion is included. The core rod 3 is horizontally divided into two parts, an upper core 31 and a lower core 32, on a plane that is flush with the upper surface of the step portion 2 of the lower core 32. Since the upper core 31 and the lower core 32 have a concave and convex at the central part on the cross section 5 along which the core rod 3 has been divided, they are simply joined by fitting the concave and convex. The corner between the upper surface of the step portion 2 of the stepped core rod and the side surface linked to the upper surface is not curved.

Shot peening is applied to the cross section 5, through which the upper core 31 and lower core 32 are separated, the step's upper surface flush with the cross section 5, and the side surface linked to the step's upper surface, so as to provide compressed residual stress.

A lower punch 121 is disposed on the outer surface of the stepped core rod 32, another lower punch 120 is disposed on the outer surface of the lower punch 121, and a die 106 is disposed on the outer surface of the lower punch 120. Powder is filled in a cavity which is formed by the die 106, the two lower punches 120, 121 and the stepped core rod 3, and then a load is applied to the upper punch 104, and a load is also applied from the lower side as the two lower punches 120, 121 and the core rod 101 are relatively raised to form a green compact 500 that constitutes a 3D motor core. The lower punch 121 adjacent to the core has a stepped structure in their peripheral direction.

Soft magnetic iron powder was used and a load was applied so that the density of the protrusion structure of the green compact 500 and the entire density of the green compact 500 became 92% or more. At this high density, cracks are usually generated at a corner of the stepped core rod, causing the core rod to be damaged in a short period of time. In this present invention, however, the core rod is divided into two cores at its corner and the divided cores are joined, so damage to the core rod is suppressed. Furthermore, shot peening is performed to apply a compressed residual stress, and thereby high-cycle life of the core rod to destruction is prolonged.

In this embodiment, a green compact 500 having 12 protrusions 501 on the upper surface of a ring-shaped structure and another green compact 500 having 30 protrusions 501 thereon were formed, as shown in FIGS. 17 to 19. A part at which the end surface 502 of the protrusion 501 and its internal side 503 are joined is not curved, so the end surface 502 can be made flat.

According to detailed analysis of the joining part between the end surface of the protrusion on the green compact and its internal surface, it was found that the joining part was not curved rather than being curved.

Accordingly, even when the width of the end surface 502 is small, the flat area on the end surface can be enlarged.

When the flatness of the protrusion of the green compact is increased, the following effects are obtained.

1) When the protrusions are stacked on their end surfaces, if the end surface is flat, the tightness of contact among them is increased.

When the end surface is jointed to a plane-shaped material, the joining area can be maximized, increasing the contact force. In addition, unnecessary space can be eliminated.

2) A flat end surface is preferable in thin units because their thicknesses can be reduced.

The curvature radius R in this embodiment is 0. Even if the curvature radius R is not 0, when R/δ is smaller than 0.2 or R is smaller than 0.1 mm, the above effects are sufficiently obtained; δ is the width 502 of the end surface of the protrusion.

The effects are further increased as R/δ is reduced to smaller than 0.1 and to smaller than 0.05. The effects are also increased as R is reduced to smaller than 0.1 mm and to smaller than 0.05 mm.

When the entire density of the green compact is increased to as high as 92% or more of the true density of the material constituting the powder, the following effects are obtained.

1) The strength of the green compact is increased.

2) The green compact is advantageous when it is mounted in a mounted part in which space is limited.

3) Net shaping is possible for forming, increasing the productivity.

When the core rod is used for the compacting of, for example, a motor core made of a powder core material, the following effects are further obtained.

4) The magnetic flux density is increased and thereby the motor output and motor torque are increased.

5) When the magnetic flux density is the same as before, the powder core can be made compact.

As the entire density of the green compact is increased to 94% or more and to 96% or more of the true density of the material constituting the powder, the above effects are further increased.

Since the maximum stress is eliminated, the following effects are also obtained.

1) Stresses are averaged and thereby the density of the green compact can be made uniform.

2) The residual stress, which concentrates on a single place of the powder core, can be reduced and thereby the hysteresis loss is reduced.

3) When a powder core is formed by compacting soft magnetic powder material with insulating coating, stresses are averaged and are not localized, so the insulating coatings are less destructed and eddy current loss is reduced.

4) The life of the die assembly is prolonged.

5) This embodiment is effective for motor parts, actuator parts, and electrical components.

### Sixth Embodiment

If a corner jointed to two or more surfaces of a plurality of surfaces joined to end surfaces or dent surfaces of a green compact is not curved in the first to fifth embodiments, the effects obtained by making the end surfaces or dent surfaces flat are further increased as described below.

1) When an axial gap motor, in which the end surfaces of the extrusions on the green compact is close to magnet of rotor and thereby gaps among them are small, or a similar product is used, flat end surfaces make it hard to stop the rotation of the motor and suppress noise when the extrusions touch one another.

2) When the protrusions are stacked on their end surfaces, if the end surface is flat, the tightness of contact among them is increased.

When the end surface is jointed to a plane-shaped material, the joining area can be maximized, increasing the contact force. In addition, unnecessary space can be eliminated.

3) A flat end surface is preferable in thin units because their thicknesses can be reduced.

This embodiment is effective for motor parts, actuator parts, and electrical components.

### Seventh Embodiment

In the first to fifth embodiments, let A be the average radius of the outer surface of the green compact. The width δ of the end surface of the protrusion or the width δ in a radial direction of the dent portion has the following relationship; when δ/A is smaller than 0.2 or δ is smaller than 3 mm, the ring width is reduced. Even when the ring width is small, the green compact can be made compact with its part characteristics unchanged because the end surface is flat. The compactness is increased as δ/A is reduced to smaller than 0.1 and to smaller than 0.05 or δ is reduced to smaller than 2 mm or to smaller than 1 mm. This embodiment is effective for motor parts, actuator parts, and electrical components.

### Eighth Embodiment

In the first to fifth embodiments, let h be the height of the protrusion of the green compact, the height of the step portion, or the depth of the dent portion. When h/δ is greater than 2, the width of the ring of the green compact is reduced and its thickness is increased. Even when the ring width is small, the green compact can be made compact with its part characteristics unchanged because the end surface is flat. The compactness is increased as h/δ is increased to greater than 4 and to greater than 8.

This embodiment is effective for relatively thick motor parts, actuator parts, and electrical parts.

### Ninth Embodiment

When the density of the protrusion is increased to 94% or more of the true density by increasing the load applied to the protrusion during the compacting of the green compact in the first to fifth embodiments, the following effects are provided.

1) The strength of the green compact is increased.

2) The green compact is advantageous when it is mounted in a mounted part in which space is limited.

3) Net shaping is possible for forming, increasing the productivity.

When the core rod is used for the compacting of, for example, a motor core made of a powder core material, the following effects are further obtained.

4) When the magnetic flux density is the same as before, the powder core can be made compact.

As the density of the protrusion is increased to 96% or more and to 98% or more of the true density, the above effects are further increased.

5) This embodiment is effective for motor parts, actuator parts, and electrical components.

### Tenth Embodiment

Only the upper element of the divided core rod can be replaced to a modified upper element in response to the shape of the protrusion or dent portion of the green compact formed in the first to fifth embodiments. Accordingly, the mold can be replaced quickly at a low cost.

### Eleventh Embodiment

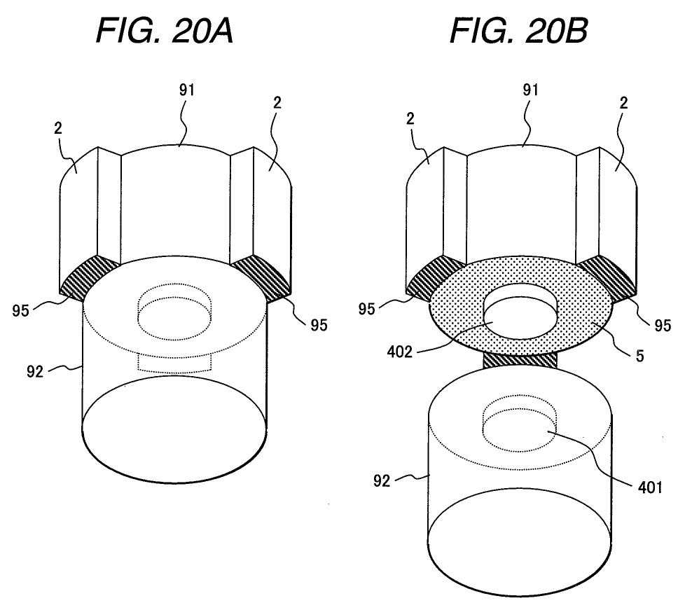

An eleventh embodiment in which a core rod 3 having a step portion 2 is used will be described below with reference to FIGS. 20A and 20B.

The core rod 3 shown in FIGS. 20A and 20B has three step portions 2, which are convexes extending in radial directions, in the peripheral direction. The core rod 3 is divided into an upper core 91 and a lower core 92 on a plane flush with the lower surface 95 of the step portion 2; the upper core 91 and the lower core 92 are joined with a bolt 401 a nut 402 on the plane along which the core rod 3 is divided. The cross section 5, which is the plane on which the core rod 3 is divided into the upper core 91 and the lower core 92, is linked to the lower surface 95 of the step portion 2. Even when a core rod shaped in this way is used, green compacts as described in the first to fifth embodiment can also be formed.

What is claimed is:

1. A core rod for forming a cylindrical green compact having an axial protrusion or a radial step portion or dent portion on an inner surface of the cylindrical member by powder compaction, wherein:
the core rod is provided with a step portion protruding in a radial direction at least a part on an outer surface thereof;
the core rod is divided into two parts, an upper core and a lower core, on a plane that is flush with an upper surface of the step portion; and
the upper core and lower core are mechanically joined with fastening members or bonded with an adhesive on a plane along which the core rod is divided.

2. The core rod according to claim 1, wherein the upper core and lower core of the core rod are joined with a bolt or a screw at the center of the plane along which the core rod is divided, or by forming a concave in one of the divided core and a convex on the other divided core, and fitting the divided cores to each other.

3. The core rod according to claim 1, wherein at least one of the upper core and the lower core is surface-treated by shot peening on the plane along which the core rod is divided, so as to provide compressed residual stress.

4. The core rod according to claim 1, wherein the upper core of the divided two cores, the upper core and the lower core, is capable of being replaced to a modified upper core in response to a shape of the cylindrical green compact formed by powder compaction.

5. The core rod according to claim 1, wherein a corner at a joint part between an upper surface of the step portion and the core rod satisfies at least one of conditions described below:
1) The corner is not curvature.
2) R/δ is smaller than 0.2, where R is a curvature radius of the corner and δ is a width of the step portion in a radial direction.
3) R is smaller than 0.1 mm, where R is a curvature radius of the corner.

6. An apparatus for forming a cylindrical green compact having an axial protrusion or a radial step portion or dent portion on an inner surface of the cylindrical member by powder compaction, the apparatus comprising:
a core rod which is provided with a step portion protruding in a radial direction at least a part on an outer surface thereof, and being divided into an upper core and a lower core on a plane that is flush with an upper surface of the step portion; and
the upper core and lower core are mechanically joined with fastening members or bonded with an adhesive on a plane along which the core rod is divided;
an upper punch and a lower punch disposed on an outer surface of the core rod; and
a die disposed on outer surfaces of the upper punch and the lower punch; wherein
the powder is filled between the upper punch and the lower punch, and the upper punch and the lower punch are relatively moved to apply a load to the powder for forming a cylindrical green compact.

7. A method for forming a cylindrical green compact having an axial protrusion or a radial step portion or dent portion on an inner surface of the cylindrical member by powder compaction, the method comprising the steps of:
using a core rod which is provided with a step portion protruding in a radial direction at least a part on an outer surface thereof, and divided into an upper core and a lower core on a plane that is flush with an upper surface of the step portion, mechanically joining with fastening members or bonding with an adhesive the upper core and lower core with fastening members on a plane along which the core rod is divided;
disposing an upper punch and a lower punch on an outer surface of the core rod;
disposing a die on outer surfaces of the upper punch and the lower punch;
filling powder between the upper punch and the lower punch and between the core rod and the die; and
relatively moving the upper punch and the lower punch to apply a load to the powder for forming a cylindrical green compact.

8. The method according to claim 7, further comprising the steps of:
fixing the lower punch above the step portion formed on the outer surface of the core rod; and
moving the upper punch for powder compaction of the powder filled between the upper punch and the lower punch so as to form a cylindrical member having a protrusion in an axial direction at least one part on an inner surface of the cylindrical member.

9. The method according to claim 7, further comprising the steps of:
fixing the lower punch below the step portion formed on the outer surface of the core rod; and
moving the upper punch for powder compaction of the powder filled between the upper punch and the lower punch so as to form a cylindrical member having a dent in a radial direction at least one part on an inner surface of the cylindrical member.
